(19) United States
(12) Patent Application Publication
(10) Pub. No.: US 2006/0096845 A1
(43) Pub. Date: May 11, 2006

(54) Rotary actuator

(75) Inventor: Oliver Zegula, Bad Neustadt (DE)

Correspondence Address: BIRCH STEWART KOLASCH & BIRCH, PO BOX 747, FALLS CHURCH, VA, 22040-0747, US

(73) Assignee: Preh GmbH, Bad Neustadt a.d. Saale (DE)

(21) Appl. No.: 11/270,493

(22) Filed: Nov. 10, 2005

(30) Foreign Application Priority Data
Nov. 10, 2004 (DE) 10 2004 054 178.7

(51) Int. Cl. H01H 13/14

(52) U.S. Cl. 200/341

(57) ABSTRACT

A control element for control devices for motor vehicles is provided. The control element includes a rotary actuator seated in bearings, and a stationary key located inside the rotary actuator, and a means for forming a click-stop arrangement, whereby by the bearing, particularly a ball bearing, the rotary actuator is rotatably positioned on an axis that houses the interior key.

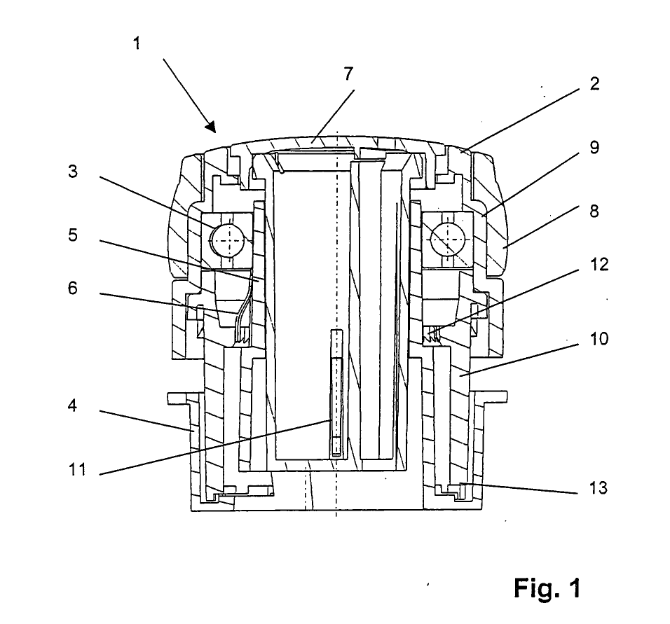

This nonprovisional application claims priority under 35 U.S.C. §119(a) on German Patent Application No. DE 102004054178.7, which was filed in Germany on Nov. 10, 2004, and which is herein incorporated by reference.

### BACKGROUND OF THE INVENTION

1. Field of the Invention

The present invention relates to a control element for control devices in motor vehicles having a rotary actuator seated in bearings and a stationary push button/key/key arranged inside the rotary actuator, and a means to form a click-stop.

2. Description of the Background Art

Nowadays, a plurality of control elements need to be adjusted in motor vehicles, whereby a trend is moving toward the utilization of a single rotary actuator with which to carry out this plurality of control functions in order to set parameters for a selected control function, or to chose from various options. If rotary actuators of this kind can be freely turned in both directions, an optical feedback signal for the parameter settings, that is, the selected option, is required, both when the parameters are set and when a selection from the available options is made. In order to provide the operator with at least some perception when turning the rotary actuator of the rotary knob, it is known to generate a plurality of clicks that are lightly tactile on the rotary knob. Thus, the operator receives an optical feedback signal via a default value or a selection range that is set proportionally to the click.

An actuator element having a rotary actuator and a stationary core, which is seated on bearings inside the shell, is described in DE 102 34 512 A1. The rotary actuator, which in this publication is referred to as a rotation knob, receives its clicks via guide races, which in interaction with the ball bearings generate an up and down movement and thus transfer an optical feedback to the operator.

A further control element for control devices in motor vehicles having a shell and a rotating knob, which sets control functions via an axis of rotation, and a click-stop device for default click-stop positions of the rotating knob as indicated by symbols is described in DE 195 17 781 C2. In this publication, the click-stop element interacts with a ratchet wheel, which is attached to the shell, and which is a one-piece component molded to the rotating knob. With a connector, which extends into the control element, the control element can be manipulated, whereby the control element is seated in a friction bearing.

Furthermore, a rotary actuator having a stationary interior key and a means for forming a click-stop is known from unpublished German Patent Application No. DE 10 2004 035 960. Disclosed therein is the arrangement of two rotary actuators having respectively separate click-stop functions in one control element. The stop springs interact thereby with a stationary bearing block, whereby the stop spring is either received in the bearing block, or the stop spring acts against a snap-in configuration of the bearing block.

### SUMMARY OF THE INVENTION

It is therefore an object of the present invention to provide a control element with an improved surface feel, has a simple construction, and which can be produced cost-efficiently and which, furthermore, adds to the operator's comfort and projects a top-value look. In addition to these benefits, the click-stops of the control element are to be very smooth.

The solution found in the present invention is such that by a bearing, such as a ball bearing, the rotary actuator is rotatably seated on an axis, which houses the interior key. By using a bearing of the present invention, it is now possible to have very smooth, free-of-play click-stop increments over the entire rotation range of the rotary actuator. The use of a standard, mass-produced bearing thereby has a positive effect on the manufacturing costs. Furthermore, standard bearings have the advantage that their durability far exceeds the rotations of a control element, that is, a rotary actuator. By making the knob surface of a synthetic material with a plasticizer added, the comfort level of the operator of the rotary actuator is increased since the operator does not have to handle a rotary actuator that is made of metal or hard plastic. Rather, the soft synthetic material is pliable in the hand of the operator, which in turn makes it pleasant to handle. Furthermore, the multi-part construction of the rotary actuator, namely knob surface, rotary knob carrier and coding ring is beneficial for the optical appearance so that a high-class impression can be created. It is thereby conceivable within the scope of the present invention to have a colored knob surface, for example, black, or to coordinate it with the interior design of the vehicle and design the rotary knob carrier, a further visible element of the control element, with a metallic coating, or merely with a metallic-like surface. The control element, preferably the rotary actuator, can thus be coordinated with the vehicle's interior design, which in turn contributes to the optical appearance.

Additionally, the haptic sensation is further improved as a result of the touch-free transfer of the rotational motion.

The control element can be made of synthetic materials. The knob surface thereby includes materials that make the knob surface soft to the touch. The rotary knob carrier and the coding ring can be made of hard synthetic materials like POM (polyoxymethylene), for example. Likewise, shells, axes, and key are made of standard synthetic materials as commonly used for control elements. It goes without saying that there are translucent or transparent areas in the upper, visible area of the key if suitable back-illumination is provided for the key. The stop spring can be made of conventional steel for springs, and the bearing can be made of hardened steel.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein the figure shows a cross section of a control element according to an embodiment of the present invention.

### DETAILED DESCRIPTION

The control element 1 of the present invention is comprised of the rotary actuator 2, the bearing 3, the shell 4, an axis 5 that is a one-piece unit that is molded to the shell, a stop spring 6, and an interior stationary key 7. The rotary actuator 2 of the present invention includes a knob surface 8, a rotary knob carrier 9, and a coding ring 10.

The shell 4 is a receptacle for the control element 1 in a control panel area (not illustrated) of a motor vehicle. It goes without saying that the shell 4 can be provided with additional means necessary for additional click-stop configuration or mounting in the control panel area. The one-piece axis 5 is molded to the shell 4 and reaches all the way to the upper area of the key 7. On the one hand, the axis 5 serves as a receptacle for the key 7, which is guided in the axis 5 by a linear guide, and on the other hand, it is a receptacle for the bearing 3. The inside of the key 7 is hollow so that the key can be back-lit and/or can be provided with an illuminatable indicator element. It is thereby conceivable to arrange the illuminators or light guide elements below the key 7, which then back-light the key 7. Furthermore, it is possible to equip the key with a freely programmable symbolic language so that for each designated menu for the control element 1, an adequate symbol can be displayed on the outer surface of the key 7. The key 7 executes a linear up and down movement in the direction of the middle axis, whereby to simplify matters, the spring elements acting against the key 7 are not illustrated.

On the exterior circumferential surface of the axis 5, a stop spring 6 is arranged in the upper area immediately below the bearing 3. The stop spring 6 acts against a click-stop configuration 12 of the coding ring 10. In this embodiment, the stop spring 6 has an M-shaped contour, whereby the two outer arms of the stop spring 6 keep the stop spring 6 on the axis 5, and the middle area of the stop spring abuts to the snap-in configuration 12, thus forming the stop. However, it is also conceivable to mount the stop spring 6 on the coding ring 10 and to incorporate a suitable snap-in configuration 12 into the axis 5.

In addition to housing the stop spring 6, the axis 5 also serves as a receptacle for the bearing 3. In this embodiment, the bearing 3 is friction-locked to the axis 5, however, it is also conceivable to incorporate the axis 5 in a suitable positive configuration. It is thereby conceivable that the bearing abuts to a suitable shoulder on the axis 5. Any conventional standard bearings can be used for bearing 3. The deployment of a bearing 3, be it a ball, roller, cylinder, needle or a friction bearing, provides an extremely good guidance of the rotary actuator 2 and at the same time assures that the product life of the control element 1 is in compliance with the specification of the automobile industry. By deploying a standardized bearing 3, whereby it is expressly noted here that not only the bearings listed above but any kind of bearing 3 can be deployed, a cost-efficient fabrication of the control element 1 can be realized on the one hand, and on the other hand it assures that the click-stop arrangement is smooth over the entire turning area of the rotary actuator 2. Thus, due to the bearing 3, an easy operation of the rotary actuator 2 is assured, while at the same time, via the stop spring 6 and the suitable construction of the snap-in configuration 12, any locking strength and number of click-stops can be set up.

In this embodiment, the rotary actuator 2 is essentially comprised of three elements: knob surface 8, rotary actuator 2, and coding 10. The knob surface 8 can be made of a synthetic material and can include a plasticizer so that it is characterized by a soft, rubber-like flexibility. Apart from the knob surface 8, the rotary actuator 2 includes a rotary knob carrier 9, which is made of hard plastic. Furthermore, in one variation of the embodiment, the material of the rotary knob carrier 9 has the feature that it can be galvanized. By galvanizing the rotary knob carrier 9, it is possible to create a surface of the rotary actuator 2 that is easy to care for and projects a high-quality image for design purposes. In a further variation of the embodiment of the control element 1, it is also conceivable to fabricate the rotary knob carrier 9 from a metallic material. It is likewise conceivable to fabricate the rotary knob carrier 9 from a metallic-like material. The rotary knob carrier 9 is seated on the bearing 3, supporting the coding ring 10 at the same time.

On the one hand, the coding ring 10 has the function to form a suitable click-stop arrangement on the rotary actuator 2 in interaction with the stop spring 6, and furthermore has the function to record the rotational movements of the rotary actuator 2. The widest variety of designs for the coding ring 10 in the lower area 13 is thereby conceivable. A first variation of the embodiment is the deployment of an optical encoder, whereby a light barrier formed of a transmitter and a receiver is interrupted by extensions in the lower area 13. In this variation of the embodiment, the lower area 13 has an end the shape of which can be described as being similar to pinnacles of a fortress. If at least one light barrier is formed of a transmitter and a receiver, a turning motion of the rotary actuator 2 can be detected. Furthermore, by deploying two or more light barriers, the rotational direction of the rotary actuator 2 is detectable if suitable evaluation electronics are used. The construction of the lower area 13 of the coding ring 10 as a serration is, naturally, adjustable to the number of light barriers.

In a further embodiment of the invention, the rotational movement of the rotary actuator 2 can be determined with Hall sensors and magnetized areas in the lower area 13 of the coding ring 10. For this purpose, there are at least two Hall sensors attached to a circuit board below the lower area 13 of the coding ring 10, which point in the direction of the coding ring 10. In this embodiment, the upper front surface of the lower area 13 of the coding 10 has multipolar magnetization so that via the magnetization in interaction with the Hall sensors, detection of the rotational movement and the direction of the rotation can be achieved. Both in the optical and the magnetic illustration of the construction of an encryption, a four-bit Gray code can be detected by at least two receivers, with which the direction of the rotation and the number of rotation steps can be registered.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A control element for control devices in motor vehicles, the control element comprising:
a rotary actuator;
a stationary key being arranged in an interior of the rotary actuator;
a click-stop arrangement for providing audible and/or tactile response upon rotation of the rotary actuator;
an axis structure for supporting the stationary key; and
a bearing being provided between the rotary actuator and the axis structure for facilitating rotation of the rotary actuator about a circumference of the axis structure.

2. The control element according to claim 1, wherein the rotary actuator is formed of an exterior knob surface structure, a rotary knob carrier, and a coding ring.

3. The control element according to claim 2, wherein the exterior knob surface structure, the rotary knob carrier, and the coding ring are non-rotably connected with one another, wherein the rotary knob carrier is connected ot the coding ring, and wherein the exterior knob surface structure is substantially formed on an outer periphery of the rotary knob carrier.

4. The control element according to claim 2, wherein an encoder is provided in a lower end of the coding ring, the encoder facilitating the rotations of the rotary actuator to be optically, magnetically, or electrically codable.

5. The control element according to claim 4, wherein the encoder is formed of at least one Hall sensor and a magnetizable area located at the lower end of the coding ring.

6. The control element according to claim 4, wherein the encoder is formed of at least one transmitter and at least one receiver, and of a serration located at the lower end of the coding ring, the serration being arranged between the transmitter and the receiver.

7. The control element according to claim 2, wherein a spring is arranged between the coding ring and the axis for forming a portion of the click-stop arrangement.

8. The control element according to claim 7, wherein the spring is mounted on the axis, and wherein the spring interacts with a click-stop configuration provided on the coding ring.

9. The control element according to claim 2, wherein the rotary knob carrier is made of a material that is metallic, or can be metallicized, and/or is metallic-like.

10. The control element according to claim 2, wherein the bearing is arranged between the rotary knob carrier and the axis structure.

11. The control element according to claim 2, wherein the exterior knob surface structure is made of a plasticized synthetic material.

12. The control element according to claim 1, wherein the stationary key can be backlit and/or is provided with an illuminatable display element.

13. The control element according to claim 1, wherein the stationary key is equipped with a freely programmable symbolic language.
